(19) United States
(12) Patent Application Publication
(10) Pub. No.: US 2009/0118011 A1
(43) Pub. Date: May 7, 2009

(54) GAME MACHINE, GAME MACHINE CONTROL METHOD, AND INFORMATION STORAGE MEDIUM

(75) Inventor: Hideyuki Tsujimoto, Saitama (JP)

Correspondence Address: SUGHRUE MION, PLLC, 2100 PENNSYLVANIA AVENUE, N.W., SUITE 800, WASHINGTON, DC, 20037, US

(73) Assignee: KONAMI DIGITAL ENTERTAINMENT CO., LTD., Minato-ku , Tokyo (JP)

(21) Appl. No.: 12/295,223

(22) PCT Filed: Dec. 18, 2006
(86) PCT No.: PCT/JP2006/325184

§ 371 Date: Sep. 29, 2008

(30) Foreign Application Priority Data
Mar. 29, 2006 (JP) 2006-091966

(51) Int. Cl. A63F 9/24; A63F 13/00

(52) U.S. Cl. 463/36

(57) ABSTRACT

Provided is a game machine which can support a user to change a trajectory of a moving object to a desired trajectory in a game in which the moving object located in a game space moves along a trajectory determined according to content of an operation performed on a controller. A desired trajectory data acquiring section (70) acquires desired trajectory data indicating the desired trajectory inputted by handwriting by the user. A corresponding operation judging section (72) judges the content of the operation corresponding to the desired trajectory based on the desired trajectory data acquired by the desired trajectory data acquiring section (70). A corresponding operation guiding section (74) guides the user to the content of the operation judged by the corresponding operation judging section (72).

### TECHNICAL FIELD

The present invention relates to a game machine, a game machine control method, and an information storage medium.

### BACKGROUND ART

There is known a game in which a moving object located in a game space moves along a trajectory determined according to content of an operation performed on a controller. For example, there is known a soccer game in which a trajectory of a ball object formed upon a pass, a shot, or a free kick is determined according to content of an operation performed on a controller. For example, there is known a soccer game in which a flying distance of a ball object or a height of a trajectory thereof is determined depending on a time period for which a button remains depressed, and the trajectory of the ball object is curved according to content of an operation performed on a direction button.

Non-Patent Document 1: “Jikkyo J-League Perfect Striker Official Complete Guidebook”, KONAMI CORPORATION, Dec. 30, 1996, p. 28

### DISCLOSURE OF THE INVENTION

### Problems to be Solved by the Invention

In such a game as described above, there is a case where a user does not know what kind of operation to perform to cause a trajectory of a moving object to be a desired trajectory. Therefore, there is a case where it is difficult for the user (in particular, an unskilled user) to cause the trajectory of the moving object to be the desired trajectory.

The present invention has been made in view of the above-mentioned problem, and an object thereof is to provide a game machine, a game machine control method, and an information storage medium capable of supporting a user to change a trajectory of a moving object to a desired trajectory in a game in which the moving object located in a game space moves along a trajectory determined according to content of an operation performed on a controller.

### Means for Solving the Problems

In order to solve the above-mentioned problem, a game machine according to the present invention, which executes a game in which a moving object located in a game space moves along a trajectory determined according to a content of an operation performed on control means, includes: desired trajectory data acquiring means for acquiring desired trajectory data indicating a desired trajectory inputted by handwriting by a user; corresponding operation judging means for judging the content of the operation corresponding to the desired trajectory based on the desired trajectory data acquired by the desired trajectory data acquiring means; and corresponding operation guiding means for guiding the user to the content of the operation judged by the corresponding operation judging means.

Further, a method of controlling a game machine according to the present invention, which executes a game in which a moving object located in a game space moves along a trajectory determined according to content of an operation performed on control means, includes: a desired trajectory data acquiring step of acquiring desired trajectory data indicating a desired trajectory inputted by handwriting by a user; a corresponding operation judging step of judging the content of the operation corresponding to the desired trajectory based on the desired trajectory data acquired in the desired trajectory data acquiring step; and a corresponding operation guiding step of guiding the user to the content of the operation judged in the corresponding operation judging step.

Further, a program according to the present invention is a program for causing a computer, such as a home-use game device, a portable game device, a business-use game device, a cellular phone, a personal digital assistant (PDA), and a personal computer, to function as a game machine which executes a game in which a moving object located in a game space moves along a trajectory determined according to content of an operation performed on control means, the program further causing the computer to function as: desired trajectory data acquiring means for acquiring desired trajectory data indicating a desired trajectory inputted by handwriting by a user; corresponding operation judging means for judging the content of the operation corresponding to the desired trajectory based on the desired trajectory data acquired by the desired trajectory data acquiring means; and corresponding operation guiding means for guiding the user to the content of the operation judged by the corresponding operation judging means.

Further, an information storage medium according to the present invention is a computer-readable information storage medium recorded with the above-mentioned program. Further, a program delivery device according to the present invention is a program delivery device including an information storage medium recorded with the above-mentioned program, for reading the above-mentioned program from the information storage medium and delivering the above-mentioned program. Further, a program delivery method according to the present invention is a program delivery method, while using an information storage medium recorded with the above-mentioned program, for reading the above-mentioned program from the information storage medium and delivering the above-mentioned program.

The present invention relates to a game machine which executes a game in which a moving object located in a game space moves along a trajectory determined according to content of an operation performed on control means. In the present invention, desired trajectory data indicating a desired trajectory inputted by handwriting by a user is acquired. In addition, the content of the operation corresponding to the desired trajectory is judged based on the desired trajectory data. Then, the user is guided to the content of the operation. According to the present invention, it is possible to support a user to change a trajectory of a moving object to a desired trajectory in a game in which a moving object located in a game space moves along a trajectory determined according to a content of an operation performed on the control means.

Further, according to one embodiment of the present invention, the corresponding operation judging means may include bend degree judging means for judging to which degree the desired trajectory is bent based on the desired trajectory data acquired by the desired trajectory data acquiring means, and may judge the content of the operation corresponding to the desired trajectory based on a result of judgment made by the bend degree judging means.

### BRIEF DESCRIPTION OF THE DRAWINGS

FIG. 1 are diagrams showing external appearances of a portable game device according to this embodiment.

FIG. 2 is a diagram showing a hardware configuration of the portable game device.

FIG. 3 is a diagram showing an example of a game space.

FIG. 4 is a diagram showing an example of a free kick screen.

FIG. 5 is a diagram for explaining about an initial velocity and a kick angle of a ball object.

FIG. 6 is a diagram showing an example of the free kick screen.

FIG. 7 is a diagram showing an example of the free kick screen.

FIG. 8 is a diagram showing functional blocks of the game machine according to this embodiment.

FIG. 9 is a diagram showing an example of desired trajectory data.

FIG. 10 is a flowchart showing processing for judging an operation corresponding to a desired trajectory.

FIG. 11 is a flowchart showing the processing for judging the operation corresponding to the desired trajectory.

FIG. 12 is a flowchart showing the processing for judging the operation corresponding to the desired trajectory.

FIG. 13 is a diagram for explaining the processing for judging the operation corresponding to the desired trajectory.

FIG. 14 is a diagram for explaining the processing for judging the operation corresponding to the desired trajectory.

FIG. 15 is a diagram for explaining the processing for judging the operation corresponding to the desired trajectory.

FIG. 16 is a diagram for explaining a criterion of judgment as to whether or not the desired trajectory can be realized.

FIG. 17 is a diagram showing an example of a desired trajectory check screen.

FIG. 18 is a diagram showing an overall configuration of a program delivery system according to another embodiment of the present invention.

### BEST MODE FOR CARRYING OUT THE INVENTION

Hereinafter, detailed description is given of an example of an embodiment of the present invention based on the figures. Note that herein, the description is directed to a case where a game machine according to the embodiment of the present invention is implemented by using a portable game device, but the game machine according to the embodiment of the present invention may be implemented by using a home-use game device, a business-use game device, a personal computer, a cellular phone, or a personal digital assistant (PDA), and the like.

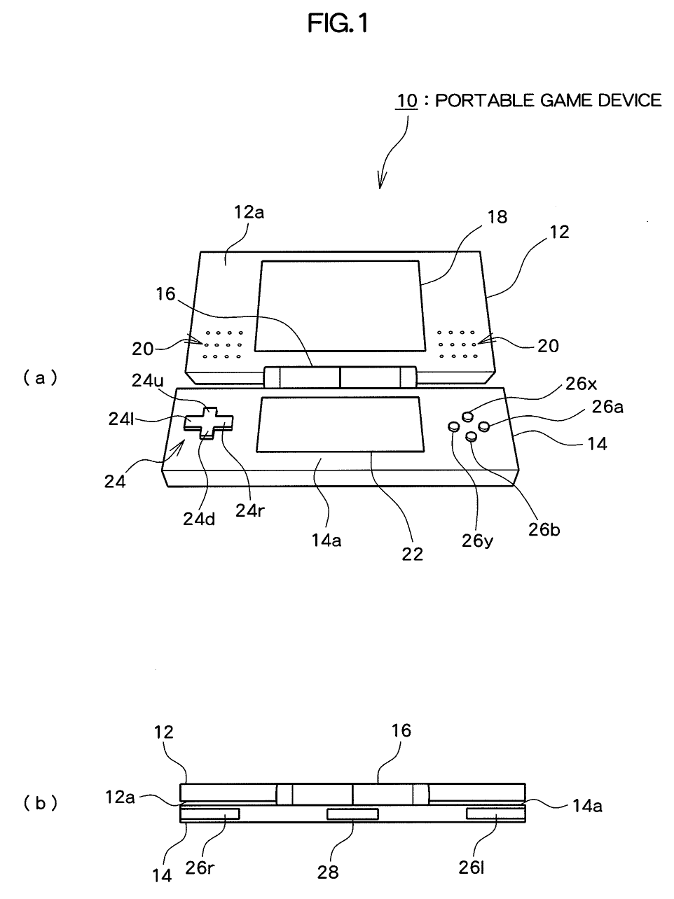

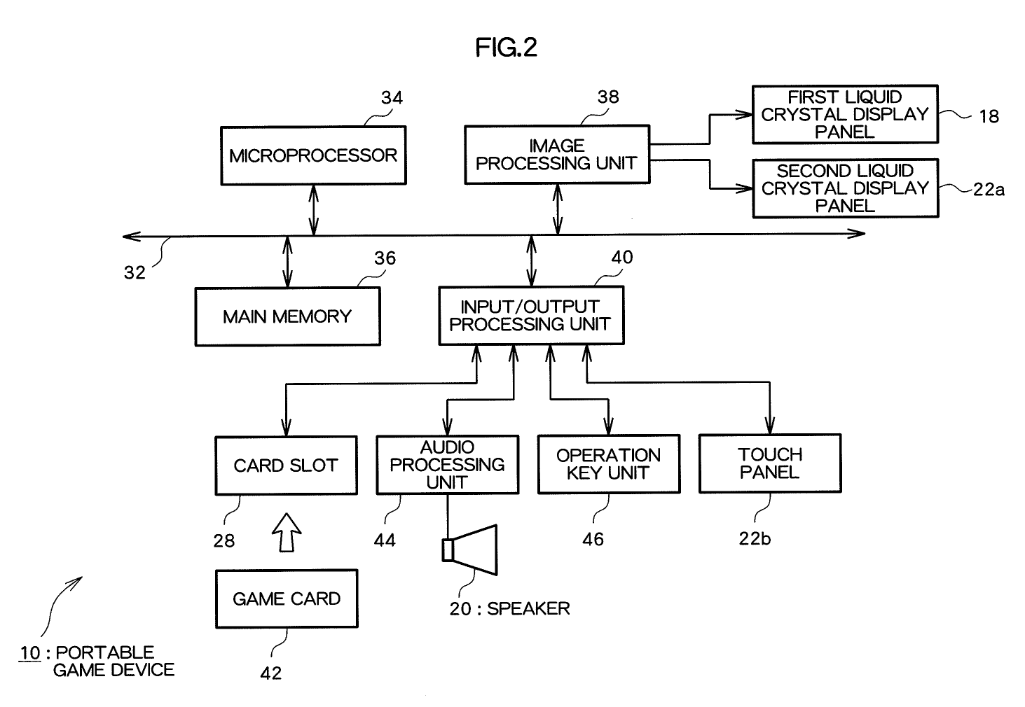

FIG. 1 show external appearances of the portable game device according to this embodiment, and FIG. 2 shows a hardware configuration of the portable game device according to this embodiment.

FIG. 1(a) is a perspective view showing how a portable game device 10 appears when viewed from a front side thereof. As shown in FIG. 1(a), the portable game device 10 is structured by including an upper casing 12 and a lower casing 14. The upper casing 12 and the lower casing 14 are coupled to each other via a hinge portion 16. The portable game device 10 assumes a play state (see FIG. 1(a)) in which a user can view a surface 12a of the upper casing 12 and a surface 14a of the lower casing 14 and a folded state (see FIG. 1(b)) in which the surface 12a of the upper casing 12 and the surface 14a of the lower casing 14 are brought together so as to face each other.

The upper casing 12 has the surface 12a provided with a first liquid crystal display panel 18. In addition, the upper casing 12 has a speaker 20 built therein. On the other hand, the lower casing 14 has the surface 14a provided with a touch screen 22, a direction button 24, and buttons 26a, 26b, 26x, and 26y. The touch screen 22 is structured by overlaying a touch panel 22b on a second liquid crystal display panel 22a. The direction button 24 includes an upward instruction portion 22u, a downward instruction portion 24d, a leftward instruction portion 241, and a rightward instruction portion 24r.

FIG. 1(b) is a back view of the portable game device 10 in the folded state. As shown in FIG. 1(b), the lower casing 14 has a back side surface provided with buttons 261 and 26r on its left and right, respectively. In addition, the back side surface of the lower casing 14 is provided in its center with a card slot 28 structured so that a game card 42 (memory card) is detachably attached thereto. The card slot 28 has an opening for receiving the game card 42, and is provided in its recessed portion with a signal input/output terminal. By pushing the game card 42 in through the opening and interconnecting the signal input/output terminal and a terminal of the game card 42, it is possible to exchange a signal between the card slot 28 and the game card 42.

The portable game device 10 is also attached with other members (not shown) such as a power switch. The portable game device 10 is battery-driven, allowing a user thereof to play a game on the portable game device 10 without selecting a place to play the game.

Further, as shown in FIG. 2, the portable game device 10 is a known computer game system including a bus 32, a microprocessor 34, a main memory 36, an image processing unit 38, the first liquid crystal display panel 18, the second liquid crystal display panel 22a, an input/output processing unit 40, the card slot 28, an audio processing unit 44, a speaker 20, an operation key unit 46, and a touch panel 22b. Those components are housed in a casing along with a battery, and are driven by the battery.

The bus 32 is used for exchanging an address and data between the respective components of the portable game device 10. The microprocessor 34, the main memory 36, the image processing unit 38, and the input/output processing unit 40 are connected to one another via the bus 32 so as to allow two-way data communications.

The microprocessor 34 controls each component of the portable game device 10 based on an operating system stored in a ROM (not shown) and a game program stored in the game card 42. The main memory 36 includes, for example, a RAM, and the game program read from the game card 42 is written to the main memory 36 as the need arises. The main memory 36 is also used as a work area for the microprocessor 34.

The first liquid crystal display panel 18 and the second liquid crystal display panel 22a are constructed of known liquid crystal display panels. The image processing unit 38 outputs game screen data generated by the microprocessor 34 to be displayed on the first liquid crystal display panel 18 and/or the second liquid crystal display panel 22a at a predetermined timing.

The input/output processing unit 40 is an interface for allowing the microprocessor 34 to exchange data with the card slot 28, the audio processing unit 44, the operation key unit 46, and the touch panel 22b. The input/output processing unit 40 is connected with the card slot 28, the audio processing unit 44, the operation key unit 46, and the touch panel 22b.

The card slot 28 reads various sorts of data such as the game program stored in the game card 42 according to an instruction from the microprocessor 34. Note that the game card 42 is used herein for supplying various sorts of data to the portable game device 10, but a CD-ROM, a DVD-ROM, and all other kinds of such information storage media may be used. Alternatively, it is possible to supply the various sorts of data from a remote site to the portable game device 10 via a communication network such as the Internet, or it is possible to supply the various sorts of data from a stationary game device, a personal computer, or the like to the portable game device 10 by using various data communications such as infrared communications.

The audio processing unit 44 includes a sound buffer, and outputs, from the speaker 20, various sorts of audio data such as game music, game effect sounds, and messages, which are stored in the sound buffer after being read from the game card 42.

The operation key unit 46 serves as input means for allowing the user to perform a game operation input, and includes the direction button 24 and the buttons 26a, 26b, 26x, 26y, 261, and 26r. The input/output processing unit 40 scans a state of each component of the operation key unit 46 every predetermined cycle (for example, every 1/60^{th} of a second), and passes an operation signal representing a result of the scanning to the microprocessor 34 via the bus 32. The microprocessor 34 judges which kind of game operation is to be performed by the user based on the operation signal.

The touch panel 22b serves as input means for allowing the user to perform the game operation input. The touch panel 22b supplies position information corresponding to a position of the touch panel 22b which is depressed by the user's finger, a pen, or the like to the microprocessor 34 via the input/output processing unit 40.

The above-mentioned portable game device 10 implements a soccer game between a user's operation subject team and an opposing team by execution of a game program read from the game card 42, for example.

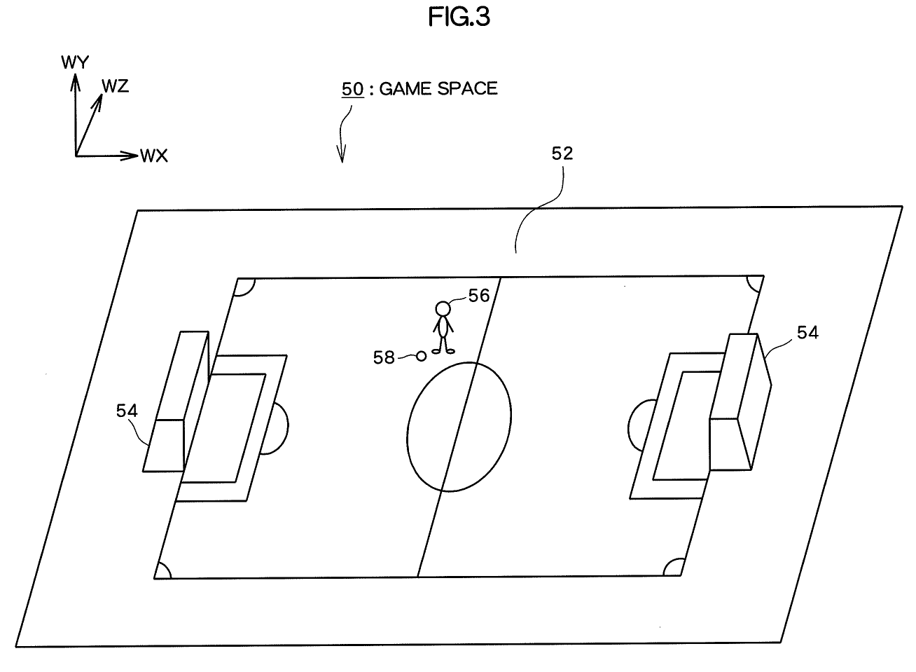

A game space (virtual three-dimensional space) is built in the main memory 26 of the portable game device 10. FIG. 3 is a diagram showing an example of the game space. As shown in FIG. 3, a field object 52 representing a soccer ground and goal objects 54 representing a goal are located in a game space 50, which forms a field where a soccer match is staged. A player object 56 representing a soccer player and a ball object 58 representing a soccer ball are located on the field object 52. FIG. 3 shows only one player object 56, but eleven player objects 56 belonging to the user's operation subject team and eleven player objects 56 belonging to the opposing team are located on the field object 52.

Any one of the player objects 56 belonging to the operation subject team is set as an operation subject of the user. The user's operation subject is switched according to movement of the ball object 58 or the like. The user's operation subject player object 56 (hereinafter, referred to as “operation subject player object”) performs various actions according to content of an operation performed on the operation key unit 46. Note that the player objects 56 belonging to the operation subject team other than the operation subject player object and the player objects 56 belonging to the opposing team (hereinafter, referred to as “opposing player objects”) are automatically controlled by the computer according to a predetermined algorithm.

For example, a virtual camera that moves according to the movement of the ball object 58 is set in the game space 50. A game screen showing a state of the game space 50 viewed from the virtual camera is displayed on the touch screen 22. The user operates the operation key unit 46 while watching the game screen displayed on the touch screen 22 to instruct the operation subject player object to perform various actions.

In the above-mentioned soccer game, if a foul event is caused by the opposing player object, a free kick screen for allowing the operation subject player object to perform a free kick is displayed on the touch screen 22.

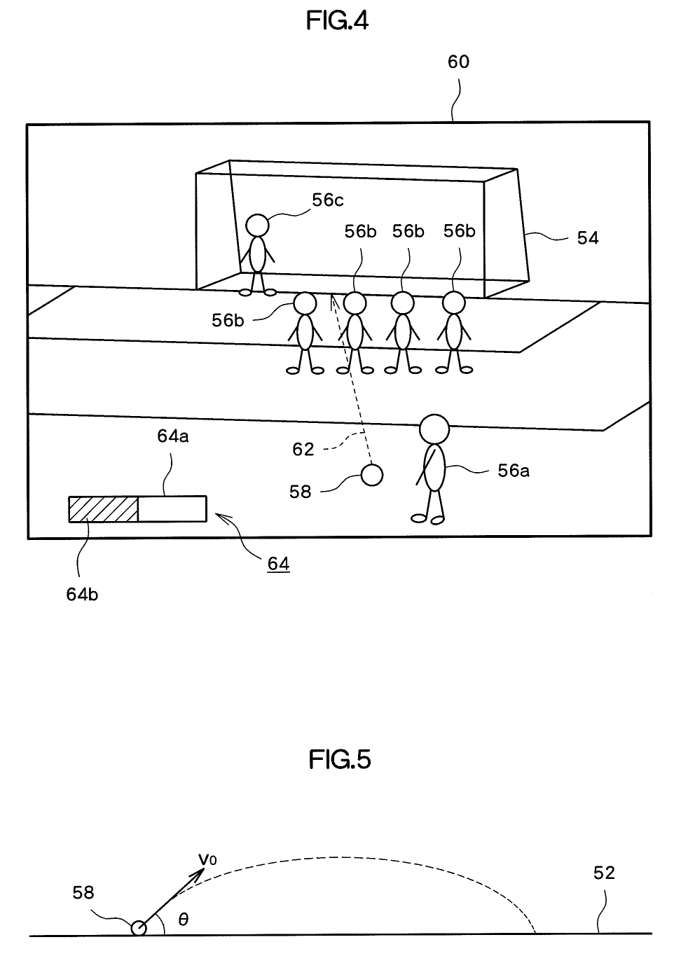

FIG. 4 shows an example of the free kick screen. Displayed on a free kick screen 60 shown in FIG. 4 are the ball object 58 located in a free kick position, an operation subject player object 56a located in a position based on the free kick position, a plurality of opposing player objects 56b located so as to form a so-called “wall”, and an opposing player object 56c representing a goal keeper.

A gage 64 is displayed on the free kick screen 60. The gage 64 includes a rectangle-shape frame image 64a and an extension image 64b located in a left-aligned manner within the frame image 64a. The extension image 64b extends according to depression of a free kick button. To be specific, before the free kick button (button 26a in this embodiment) is depressed, a left end of the extension image 64b coincides with a left end of the frame image 64a, and a length of the extension image 64b is zero. When a free kick button is depressed, the extension image 64b starts to extend, and while the free kick button remains depressed, the extension image 64b extends rightward at a constant rate as time elapses. When the depression of the free kick button is released, the extension image 64b stops extending. The length of the extension image 64b indicates the length of a time during which the free kick button remains depressed (in other words, a time from the start of depression of the free kick button until the release of the depression). As described later, the length of the extension image 64b is assumed to be a basis for determining a trajectory of the ball object 58. Note that hereinafter, the length of the extension image 64b is referred to simply as “gage length”.

On the free kick screen 60, the user sets a basic direction 62 of a free kick. The basic direction 62 is assumed to be the basis for determining the trajectory of the ball object 58 in a case where a free kick is performed. When the free kick is performed by the operation subject player object 56a, the ball object 58 moves toward the basic direction 62 as a rule. For example, the buttons 261 and 26r are used for setting the basic direction 62. When the user depresses the button 261 or 26r, the basic direction 62 is changed to a direction obtained by performing rotation counterclockwise or clockwise with the free kick position as a center.

After setting the basic direction 62 of the free kick, the user depresses the free kick button. When the free kick button is depressed, the free kick is performed by the operation subject player object 56a, and the ball object 58 starts to move. At this time, the trajectory of the ball object 58 is determined based on the basic direction 62 set by the user, the gage length, and a depressed state of the direction button 24.

For example, an initial velocity and a kick angle of the ball object 58 is determined based on the gage length. Herein, the term “kick angle” represents an angle (0) formed between a direction in which the ball object 58 is kicked and the field object 52 as shown in FIG. 5. As the gage length becomes longer, an initial velocity v₀ of the ball object 58 becomes faster, and the kick angle θ of the ball object 58 becomes larger.

The portable game device 10 stores information in which the gage length is associated with the initial velocity of the ball object 58 and information in which the gage length is associated with the kick angle of the ball object 58. For example, an operation expression for calculating the initial velocity of the ball object 58 from the gage length and an operation expression for calculating the kick angle of the ball object 58 from the gage length are stored. The initial velocity and kick angle of the ball object 58 are determined based on the information (operation expressions).

In addition, for example, at a time when the depression of the free kick button is released, if the upward instruction portion 24u is depressed, the trajectory of the ball object 58 becomes higher, and if the downward instruction portion 24d is depressed, the trajectory of the ball object 58 becomes lower.

The following expressions (1), (3), and (5) are stored in the portable game device 10 as operation expressions for calculating the initial velocity v₀ of the ball object 58 from a gage length s. Further, the following expressions (2), (4), and (6) are stored as operation expressions for calculating the kick angle θ of the ball object 58 from the gage length s. That is, functions f₁ and g₁, functions f₂ and g₂, and functions f₃ and g₃ are stored as three types of combination of functions for calculating the initial velocity v₀ and kick angle θ of the ball object 58 from the gage length s.

v₀=f₁(s) (1)

θ=g₁(s) (2)

v₀=f₂(s) (3)

θ=g₂(s) (4)

v₀=f₃(s) (5)

θ=g₃(s) (6)

Herein, the functions f₁ and g₁ are set so that the trajectory of the ball object 58 corresponding to the same gage length s becomes lower than cases of the functions f₂ and g₂ and the functions f₃ and g₃ (so that the maximum value of the kick angle θ becomes smaller than the cases of the functions f₂ and g₂ and the functions f₃ and g₃), and are used when the downward instruction portion 24d is depressed. The functions f₃ and g₃ are set so that the trajectory of the ball object 58 corresponding to the same gage length s becomes higher than cases of the functions f₁ and g₁ and the functions f₂ and g₂ (so that the maximum value of the kick angle θ becomes larger than the cases of the functions f₁ and g₁ and the functions f₂ and g₂), and are used when the upward instruction portion 24u is depressed. The functions f₂ and g₂ are set so that the trajectory of the ball object 58 corresponding to the same gage length s becomes midway between cases of the functions f₁ and g₁ and the functions f₃ and g₃ (so that the maximum value of the kick angle θ becomes midway between the cases of the functions f₁ and g₁ and the functions f₃ and g₃), and are used when neither the downward instruction portion 24d nor the upward instruction portion 24u is depressed.

In addition, for example, at a time when the depression of the free kick button is released, if the leftward instruction portion 241 is depressed, the trajectory of the ball object 58 is curved leftward, and if the rightward instruction portion 24r is depressed, the trajectory of the ball object 58 is curved rightward.

With the free kick screen 60 as described above, there are cases where the user does not know how large the gage length should be set to or what kind of operation should be performed on the direction button 24 in order to cause the trajectory of the ball object 58 to be a desired trajectory. Therefore, there are cases where it is difficult for the user (in particular an unskilled user) to cause the trajectory of the ball object 58 to be the desired trajectory. In this respect, the portable game device 10 is provided with a function (free kick operation support function) of supporting the user to cause the trajectory of the ball object 58 to be the desired trajectory.

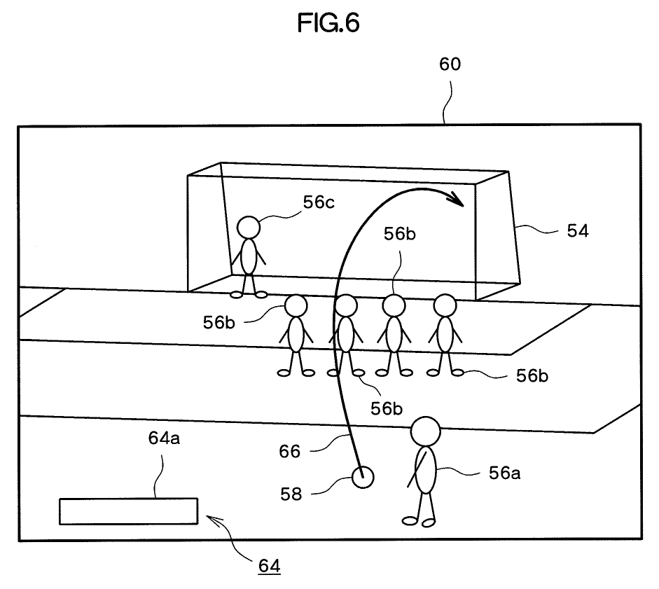

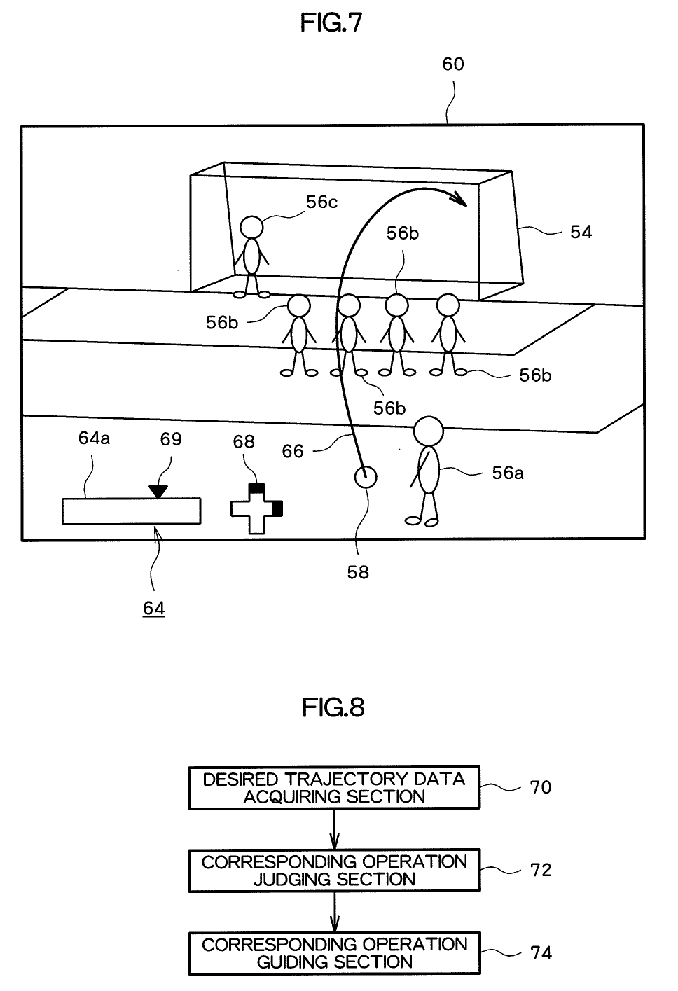

To be specific, on the free kick screen 60, when the user depresses the touch panel 22b to thereby input a desired trajectory (desired trajectory 66) by handwriting as shown in, for example, FIG. 6, images (a direction instruction operation guiding image 68 and a gage length guiding image 69) for guiding the user to an operation so as to realize the desired trajectory 66 are displayed as shown in, for example, FIG. 7.

The direction instruction operation guiding image 68 is an image for guiding the user to content of an operation performed on the direction button 24 so as to realize the desired trajectory 66. The direction instruction operation guiding image 68 allows the user to know how to depress the direction button 24 in order to realize the desired trajectory 66. Note that the direction instruction operation guiding image 68 shown in FIG. 7 indicates that the upward instruction portion 24u and the rightward instruction portion 24r are to be depressed.

The gage length guiding image 69 is an image for guiding the user to such a gage length as to realize the desired trajectory 66. The gage length guiding image 69 allows the user to know how long the gage length is to be set in order to realize the desired trajectory 66. In other words, the gage length guiding image 69 is an image for guiding the user to an operation of the free kick button so as to realize the desired trajectory 66, and the gage length guiding image 69 allows the user to know how long the free kick button is to remain depressed (when to release the depression of the free kick button).

Next, description is given of a configuration for implementing the free kick operation support function. FIG. 8 is a functional block diagram mainly showing functions related to the free kick operation support function among functions implemented by the portable game device 10. As shown in FIG. 8, the portable game device 10 functionally includes a desired trajectory data acquiring section 70, a corresponding operation judging section 72, and a corresponding operation guiding section 74. Those functions are implemented by the portable game device 10 executing a game program read from the game card 42.

### [1. Desired Trajectory Data Acquiring Section]

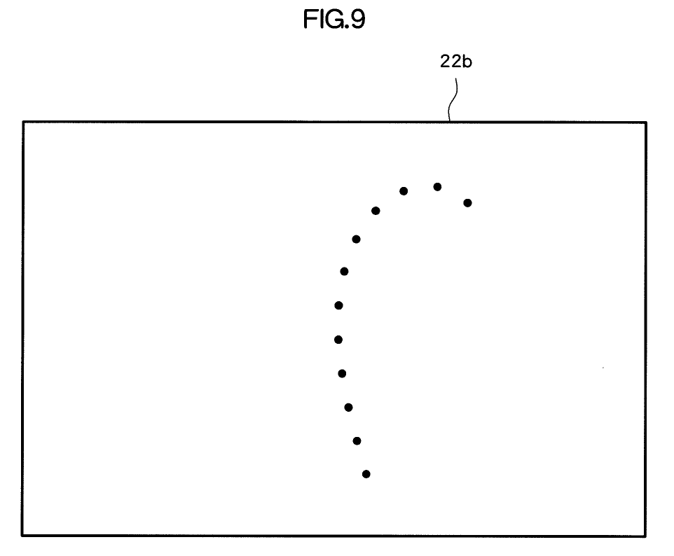

The desired trajectory data acquiring section 70 is implemented mainly by the touch panel 22b, the microprocessor 34, and the main memory 36. The desired trajectory data acquiring section 70 receives a handwritten input of the desired trajectory 66 of the ball object 58, and acquires desired trajectory data representing the desired trajectory 66 inputted by handwriting by the user. In this embodiment, the desired trajectory data acquiring section 70 acquires position information representing a depressed position on the touch panel 22b every predetermined cycle (for example, every 1/60^{th} of a second). In a case where the desired trajectory 66 as shown in FIG. 6 is handwritten on the free kick screen 60, a position information string as shown in, for example, FIG. 9, is acquired as the desired trajectory data.

### [2. Corresponding Operation Judging Section]

The corresponding operation judging section 72 is implemented mainly by the microprocessor 34 and the main memory 36. The corresponding operation judging section 72 judges the content of the operation corresponding to the desired trajectory 66 inputted by handwriting by the user based on the desired trajectory data acquired by the desired trajectory data acquiring section 70. In this embodiment information so as to realize the desired trajectory 66 is judged, including: the content of operations of the leftward instruction portion 241 and the rightward instruction portion 24r; the content of operations of the upward instruction portion 24u and the downward instruction portion 24d; and the gage length.

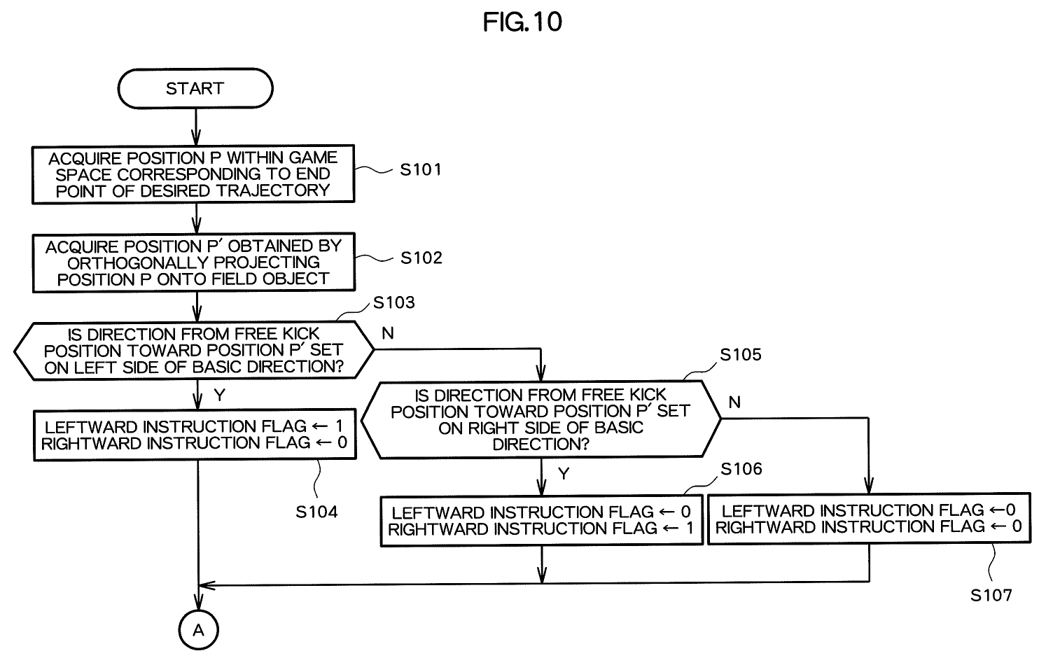

Herein, description is given of processing for judging the content of such an operation as to realize the desired trajectory 66. FIGS. 10 to 12 are flowcharts showing the processing. A program for executing the processing is read from the game card 42 and executed by the microprocessor 34 to thereby implement the corresponding operation judging section 72.

First to be executed in the processing is processing (FIG. 10) for judging the content of such operations of the leftward instruction portion 241 and the rightward instruction portion 24r as to realize the desired trajectory 66. In this processing, it is judged to what degree the desired trajectory 66 is bent with respect to the basic direction 62 of the free kick, and based on the judgment result, it is judged whether or not the leftward instruction portion 241 and the rightward instruction portion 24r need to be depressed. FIG. 13 is a diagram for explaining the content of the processing.

As shown in FIG. 10, first acquired is a position P within the game space 50 corresponding to an end point of the desired trajectory 66 (S101; see FIG. 13). In this step, the position P is acquired by assuming the position P to be a position within an area surrounded by goal posts 55, a cross bar 53, and a goal line 51. To be specific, display positions within the free kick screen 60 of both ends 55a, 55b, 55c, and 55d of the respective goal posts 55 are acquired. Subsequently acquired is a relative positional relationship between the display positions within the free kick screen 60 of both ends 55a, 55b, 55c, and 55d of the respective goal posts 55 and the position of the end point of the desired trajectory 66. Then, the position P is acquired based on the positions of both ends 55a, 55b, 55c, and 55d of the respective goal posts 55 and the relative positional relationship.

Subsequently acquired is a position P′ obtained by orthogonally projecting the position P onto the field object 52 (S102; see FIG. 13). Then, it is judged whether or not a direction OP′ from a free kick position O toward the position P′ is set on the left side of the basic direction 62 when viewed from the free kick position O toward the basic direction 62 (S103; see FIG. 13).

A case where the direction OP′ is set on the left side of the basic direction 62 is a case where the trajectory of the ball object 58 needs to be curved leftward, which is a case where the leftward instruction portion 241 needs to be depressed. In this case, a leftward instruction flag is set to 1, and a rightward instruction flag is set to 0 (S104). Herein, the leftward instruction flag is information indicating whether or not the leftward instruction portion 241 needs to be depressed. The leftward instruction flag is set to 0 if it is judged that the leftward instruction portion 241 does not need to be depressed, and set to 1 if it is judged that the leftward instruction portion 241 needs to be depressed. In a similar manner, the rightward instruction flag is information indicating whether or not the rightward instruction portion 24r needs to be depressed. The rightward instruction flag is set to 0 if it is judged that the rightward instruction portion 24r does not need to be depressed, and set to 1 if it is judged that the rightward instruction portion 24r needs to be depressed.

On the other hand, if the direction OP′ is not set on the left side of the basic direction 62, it is judged whether or not the direction OP′ is set on the right side of the basic direction 62 when viewed from the free kick position O toward the basic direction 62 (S105; see FIG. 13). A case where the direction OP′ is set on the right side of the basic direction 62 is a case where the trajectory of the ball object 58 needs to be curved rightward, which is a case where the rightward instruction portion 24r needs to be depressed. In this case, the leftward instruction flag is set to 0, and the rightward instruction flag is set to 1 (S106). On the other hand, a case where the direction OP′ is not set on the right side of the basic direction 62 is a case where the trajectory of the ball object 58 does not need to be curved, which is a case where neither the leftward instruction portion 241 nor the rightward instruction portion 24r needs to be depressed. In this case, the leftward instruction flag is set to 0, and the rightward instruction flag is set to 0 (S107).

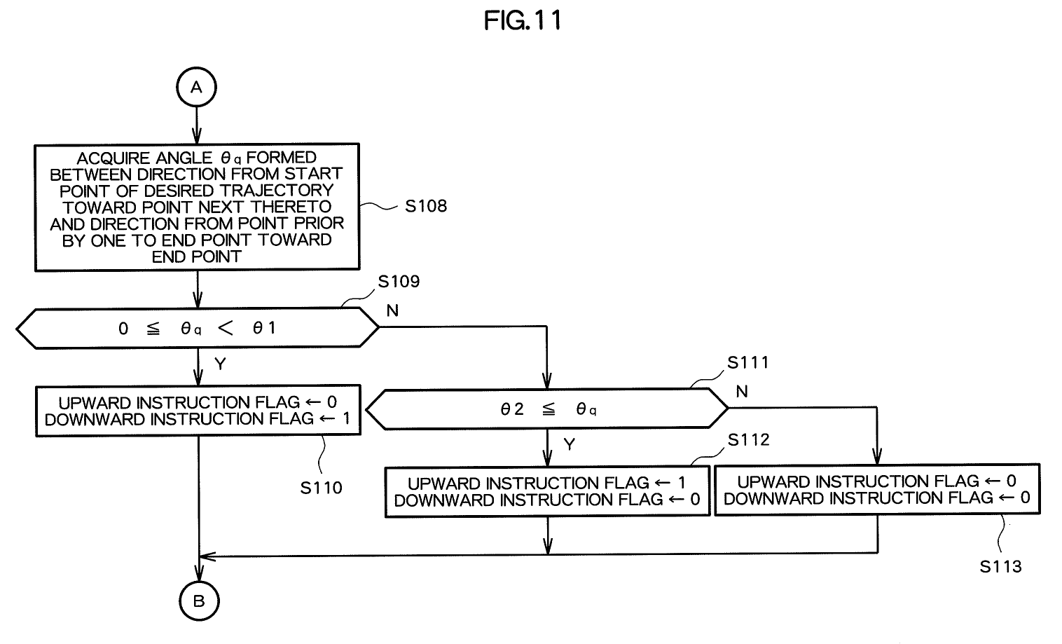

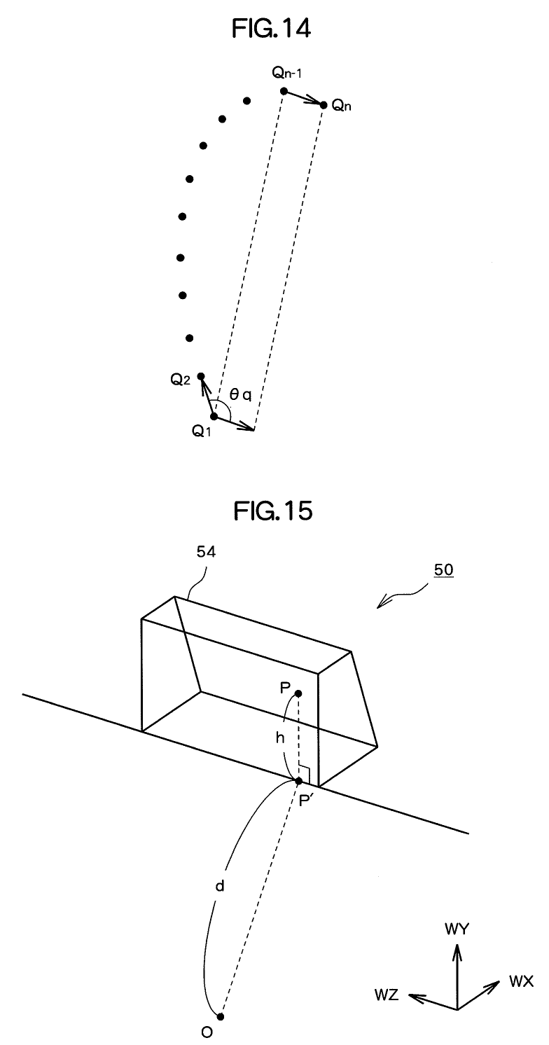

Subsequently processing (FIG. 11) is executed for judging the content of such operations of the upward instruction portion 24u and the downward instruction portion 24d as to realize the desired trajectory 66. If the desired trajectory 66 inputted by handwriting by the user is almost linear (that is, if the desired trajectory 66 is bent to a small degree), it is inferred that the user desires the trajectory of the ball object 58 to become a low trajectory. In contrast, if the desired trajectory 66 inputted by handwriting by the user is bent to a large degree, it is inferred that the user desires the trajectory of the ball object 58 to become a high trajectory. Therefore, in the processing, it is judged to what degree the desired trajectory 66 is bent, and based on the judgment result, it is judged whether or not the upward instruction portion 24u and the downward instruction portion 24d need to be depressed. FIG. 14 is a diagram for explaining the content of the processing.

As shown in FIG. 14, first acquired is an angle θq formed between a direction from a start point Q₁ (free kick position O) of the desired trajectory 66 toward a point Q₂ next thereto and a direction from a point Qₙ₋₁ prior by one to an end point Qₙ toward the end point Qₙ (S108; see FIG. 11).

Subsequently, it is judged whether or not the angle θq satisfies 0≦θq<θ1 (S109). Herein, θ1 is a predetermined reference angle. A case where the angle θq satisfies 0≦θq<θ1 is a case where it is judged that the desired trajectory 66 is almost linear (bent to a small degree), which is a case where it is judged that the downward instruction portion 24d needs to be depressed in order to lower the trajectory of the ball object 58. In this case, an upward instruction flag is set to 0, and a downward instruction flag is set to 1 (S110). Herein, the upward instruction flag is information indicating whether or not the upward instruction portion 24u needs to be depressed. The upward instruction flag is set to 0 if it is judged that the upward instruction portion 24u does not need to be depressed, and set to 1 if it is judged that the upward instruction portion 24u needs to be depressed. In a similar manner, the downward instruction flag is information indicating whether or not the downward instruction portion 24d needs to be depressed. The downward instruction flag is set to 0 if it is judged that the downward instruction portion 24d does not need to be depressed, and set to 1 if it is judged that the downward instruction portion 24d needs to be depressed.

On the other hand, if the angle θq does not satisfy 0<θq<θ1, it is judged whether or not the angle θq satisfies θ2≦θq (S111). Herein, θ2 is a predetermined reference angle, and an angle larger than θ1. A case where the angle θq satisfies θ2≦θq is a case where it is judged that the desired trajectory 66 is bent to a large degree, which is a case where it is judged that the upward instruction portion 24u needs to be depressed in order to raise the trajectory of the ball object 58. In this case, the upward instruction flag is set to 1, and the downward instruction flag is set to 0 (S112). Further, if the angle θq does not satisfy θ2≦θq (that is, if the angle θq satisfies θ1≦θq<θ2), it is judged that neither the upward instruction portion 24u nor the downward instruction portion 24d need to be depressed, and the upward instruction flag and the downward instruction flag are set to 0 (S113).

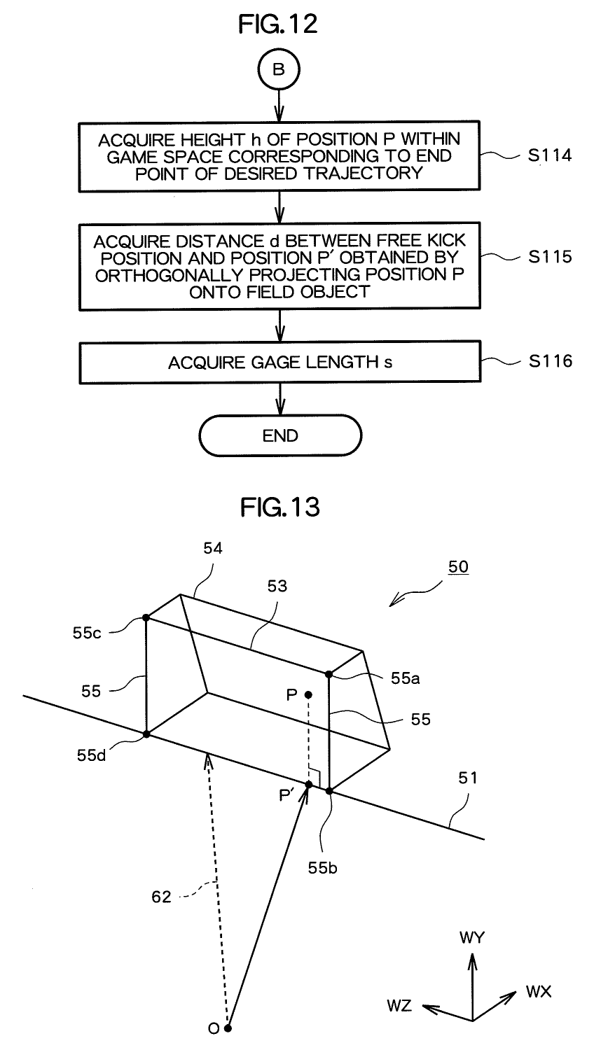

Subsequently executed is processing (FIG. 12) for judging such a gage length as to realize the desired trajectory 66. FIG. 15 is a diagram for explaining the content of the processing.

As shown in FIG. 15, first acquired is a height h (height from the field object 52) of the position P within the game space 50 corresponding to the end point of the desired trajectory 66 (S114; see FIG. 12). Note that the position P has been acquired in Step S101.

Additionally acquired is a distance d between the free kick position O and the position P′ obtained by orthogonally projecting the position P onto the field object 52 (S115; see FIG. 15).

Subsequently, the gage length s is acquired based on the height h acquired in Step S114 and the distance d acquired in Step S115 (S116).

Herein, the initial velocity v₀ and kick angle θ of the ball object 58 and the height h and distance d have relationships defined as the following expressions (7) and (8). Note that “t” in the expressions (7) and (8) represents a time that has elapsed since the ball object 58 was kicked, and “g” in the expression (8) represents gravitational acceleration.

v₀·cos θ·t=d (7)

v₀·sin θ·t−(g·t²/2)=h (8)

If the upward instruction flag is set to 1, the gage length is acquired by solving simultaneous equations (9) and (10) obtained by substituting the above-mentioned expressions (5) and (6) into the above-mentioned expressions (7) and (8).

f₃(s)·cos(g₃(s))·t=d (9)

f₃(s)·sin(g₃(s))·t−(g·t²/2)=h (10)

In a similar manner, if the downward instruction flag is set to 1, the gage lengths is acquired by solving simultaneous equations (11) and (12) obtained by substituting the above-mentioned expressions (1) and (2) into the above-mentioned expressions (7) and (8).

f₁(s)·cos(g₁(s))·t=d (11)

f₁(s)·sin(g₁(s))·t−(g·t²/2)=h (12)

Further, if the upward instruction flag and the downward instruction flag are both set to 0, the gage length s is acquired by solving simultaneous equations (13) and (14) obtained by substituting the above-mentioned expressions (3) and (4) into the above-mentioned expressions (7) and (8).

f₂(s)·cos(g₂(s))·t=d (13)

f₂(s)·sin(g₂(s))·t−(g·t²/2)=h (14)

### [3. Corresponding Operation Guiding Section]

The corresponding operation guiding section 74 is implemented mainly by, for example, the microprocessor 34, the image processing unit 38, and the audio processing unit 44. The corresponding operation guiding section 74 guides the user to the result of the judgment made by the corresponding operation judging section 72. For example, the corresponding operation guiding section 74 outputs an image, sound, or the like for guiding the user to the result of the judgment made by the corresponding operation judging section 72.

The corresponding operation guiding section 74 according to this embodiment is set by the processing shown in FIGS. 10 and 11, and displays the direction instruction operation guiding image 68 corresponding to a combination of values of the upward instruction flag, the downward instruction flag, the leftward instruction flag, and the rightward instruction flag that are stored in the main memory 36, on the free kick screen 60 at a predetermined position. For example, if the upward instruction flag and the rightward instruction flag are set to 1, and if the downward instruction flag and the leftward instruction flag are set to 0, the corresponding operation guiding section 74 displays the direction instruction operation guiding image 68 such as shown in FIG. 7 on the free kick screen 60. Further, the corresponding operation guiding section 74 displays the gage length guiding image 69 in a position based on the display position of the gage 64 within the free kick screen 60 and the gage length s obtained by the processing shown in FIG. 12 and stored in the main memory 36. That is, the corresponding operation guiding section 74 displays the gage length guiding image 69 in such a position that the length of the extension image 64b is equal to the gage length s.

According to the portable game device 10 described above, when the user handwrites the desired trajectory 66 of the ball object 58 on the free kick screen 60, the content of such an operation as to realize the desired trajectory 66 is guide-displayed, so the user becomes able to know what kind of operation should be performed in order to cause the trajectory of the ball object 58 to be a desired trajectory. In particular, an extremely intuitive interface that allows the user to handwrite the desired trajectory on the touch screen 22 is employed, so the user can easily know what operation will cause the trajectory of the ball object 58 to be the desired trajectory.

Note that the present invention is not limited to the above embodiment.

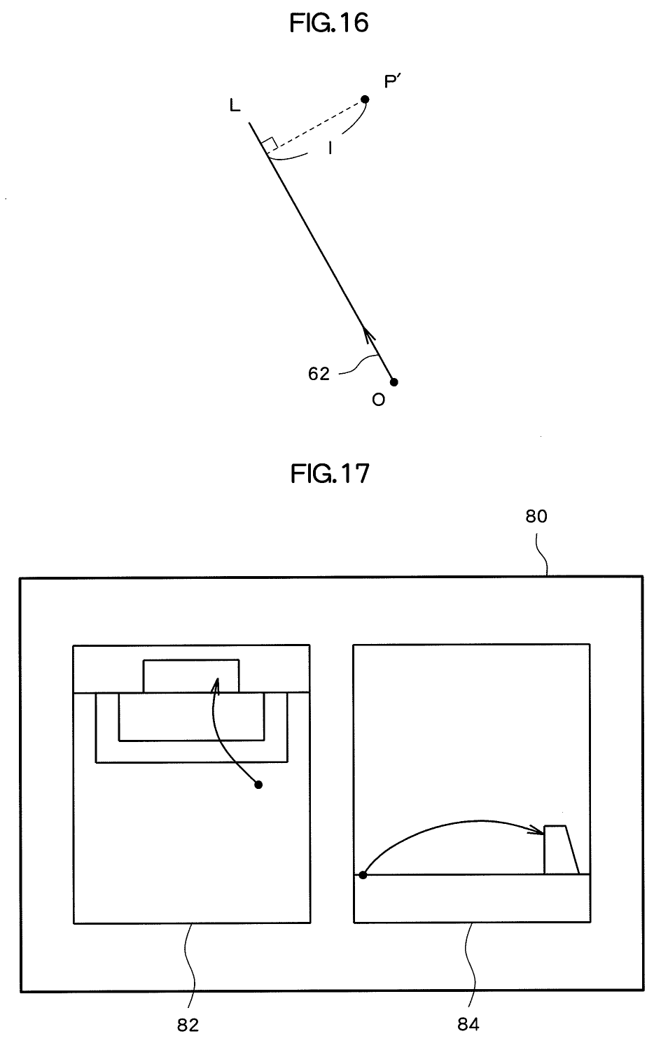

For example, if it is judged that the desired trajectory 66 inputted by handwriting by the user cannot be realized, an alert message to that effect may be displayed. For example, if the desired trajectory 66 is bent to too large a degree, an alert message to that effect may be displayed. In this case, whether or not the desired trajectory 66 is bent to too large a degree may be judged by judging whether or not a length l of a perpendicular from the position P′ (see FIG. 13 or 15) to a straight line L (straight line extending from the free kick position O toward the basic direction 62) as shown in, for example, FIG. 16 is larger than a predetermined reference value. For example, if the above-mentioned length l is larger than the predetermined reference value, it is judged that the desired trajectory 66 is bent to too large a degree with respect to the basic direction 62, and the alert message indicating that the desired trajectory 66 is bent to too large a degree may be displayed.

Further, for example, if the desired trajectory 66 is inputted by the user, a desired trajectory check screen 80 as shown in, for example, FIG. 17 may be displayed on the first liquid crystal display panel 18 (or the touch screen 22). Displayed on the desired trajectory check screen 80 shown in FIG. 17 are a desired trajectory image 82 for showing the state of the desired trajectory 66 when viewed from immediately above, and a desired trajectory image 84 for showing the state of the desired trajectory 66 when viewed horizontally. This allows the user to check whether or not the desired trajectory 66 is really what the user desires.

Further, for example, the portable game device 10 may store a table in which reference desired trajectory data is associated with operation content data items (the upward, downward, leftward, and rightward instruction flags and the gage length). If the desired trajectory data is inputted by handwriting by the user, a similarity between the desired trajectory data inputted by handwriting by the user and each of the reference desired trajectory data items may be calculated to guide the user to the operation corresponding to the desired trajectory 66 based on the operation content data associated with the reference desired trajectory data item having the highest similarity.

Further, for example, the above-mentioned soccer game may be provided with a practice mode for allowing the user to practice the free kick operation. In addition, the free kick operation support function may be effective only in this practice mode.

Further, for example, the present invention is applied not only to the soccer game. For example, the present invention may be applied to sport games (of basketball, ice hockey, and the like played by using a moving object such as a ball or a puck) in addition to the soccer game. Further, for example, the present invention may be applied to a racing game to thereby guide the user to content of an operation for causing an automotive object (moving object) to run according to a desired course plan when the user inputs the desired course plan by handwriting. The present invention is applicable to a game in which a moving object moves along a trajectory according to a content of an operation performed on control means in a game space.

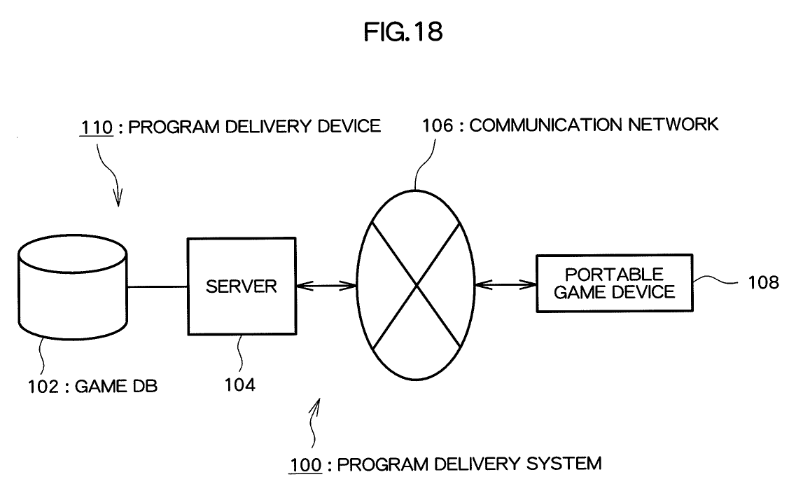

Further, in the above description, the program is supplied from the game card 42 serving as the information storage medium to the portable game device 10, but the program may be delivered to a household or the like via the communication network. FIG. 18 is a diagram showing an overall configuration of a program delivery system using the communication network. Based on FIG. 18, description is given of the program delivery system according to the present invention. As shown in FIG. 18, this program delivery system 100 includes a game database 102, a server 104, a communication network 106, and a portable game device 108. Of those, the game database 102 and the server 104 constitute a program delivery device 110. The communication network 106 includes, for example, the Internet and a cable television network. In this system, the same program as the storage content of the game card 42 is stored in the game database (information storage medium) 102. A demander uses the portable game device 108 to make a game delivery request, so the game delivery request is transferred to the server 104 via the communication network 106. Then, the server 104 reads the program from the game database 102 according to the game delivery request, and transmits the program to the portable game device 108 (game delivery request source). The game delivery is performed herein according to the game delivery request, but the server 104 may transmit the program one way. In addition, a whole program necessary to implement the game is not necessarily delivered at one time (delivered collectively), and necessary parts may be delivered (split and delivered) depending on which phase the game is in. By thus performing the game delivery via the communication network 106, the demander can obtain the program with ease.

1. A game machine, executing a game in which a moving object located in a game space moves along a trajectory determined according to content of an operation performed on control means, comprising:
desired trajectory data acquiring means for acquiring desired trajectory data indicating a desired trajectory inputted by handwriting by a user;
corresponding operation judging means for judging the content of the operation corresponding to the desired trajectory based on the desired trajectory data acquired by the desired trajectory data acquiring means; and
corresponding operation guiding means for guiding the user to the content of the operation judged by the corresponding operation judging means.

2. A game machine according to claim 1, wherein the corresponding operation judging means includes bend degree judging means for judging to what degree the desired trajectory is bent based on the desired trajectory data acquired by the desired trajectory data acquiring means, and judges the content of the operation corresponding to the desired trajectory based on a result of judgment made by the bend degree judging means.

3. A method of controlling a game machine executing a game in which a moving object located in a game space moves along a trajectory determined according to content of an operation performed on control means, comprising:
a desired trajectory data acquiring step of acquiring desired trajectory data indicating a desired trajectory inputted by handwriting by a user;
a corresponding operation judging step of judging the content of the operation corresponding to the desired trajectory based on the desired trajectory data acquired in the desired trajectory data acquiring step; and
a corresponding operation guiding step of guiding the user to the content of the operation judged in the corresponding operation judging step.

4. A computer-readable information storage medium recorded with a program for causing a computer to function as a game machine which executes a game in which a moving object located in a game space moves along a trajectory determined according to a content of an operation performed on control means,
the program further causing the computer to function as:
desired trajectory data acquiring means for acquiring desired trajectory data indicating a desired trajectory inputted by handwriting by a user;
corresponding operation judging means for judging the content of the operation corresponding to the desired trajectory based on the desired trajectory data acquired by the desired trajectory data acquiring means; and
corresponding operation guiding means for guiding the user to the content of the operation judged by the corresponding operation judging means.
